(19) United States
(12) Patent Application Publication
(10) Pub. No.: US 2010/0163386 A1
(43) Pub. Date: Jul. 1, 2010

(54) IMAGE PUSH-BUTTON ASSEMBLY STRUCTURE

(76) Inventor: Jen-Wen SUN, Sindian (TW)

Correspondence Address: Muncy, Geissler, Olds & Lowe, PLLC, 4000 Legato Road, Suite 310, FAIRFAX, VA, 22033, US

(21) Appl. No.: 12/430,711

(22) Filed: Apr. 27, 2009

(30) Foreign Application Priority Data
Dec. 31, 2008 (TW) 097223810

(51) Int. Cl. H01H 13/14

(52) U.S. Cl. 200/341

(57) ABSTRACT

An image push-button assembly structure includes primarily a base, a rest, a display screen and an upper lid. The rest is extended with a fixing element for sheathing a spring and is assembled with a holding space on the base. The rest is installed with the display screen which is fixed on a display circuit board. Then, the upper lid is covered on the rest, allowing the display screen to be located in the upper lid and the rest. The display circuit board in the rest that has been pressed down is electrically connected with the circuit board; therefore, all kinds of images of prompting messages can be observed from the display screen, allowing the push-button to have an image display function.

### BACKGROUND OF THE INVENTION

a) Field of the Invention

The present invention relates to a push-button structure, and more particularly to an image push-button assembly structure which is provided with an image display function and operates by pressing.

b) Description of the Prior Art

To activate all kinds of mechanisms, a push-button structure has been already used very popularly, wherein as being simple in structure, a push switch is widely used now; for example, a light switch for turning on illuminating equipment, a power switch for turning on computer equipment or even a computer keyboard for input on the computer equipment is also the push switch.

A conventional push switch is usually constituted by a push-button unit and a push-button seat. The push-button unit is provided with a push part to be pressed down by a user, the push-button seat holds that push-button unit and a bottom of the push-button seat is provided with a separated metal junction. After the user has pressed down the push switch, the metal junction will be connected electrically, so as to accomplish conducting electricity. On the other hand, an elastic element (for example, a spring) is usually provided between the push-button seat and the push-button unit, such that after the user has pressed down the push-button unit, the push-button unit can be bounced back to an original position by the elastic element.

This kind of push-button is only provided with a function of conducting electricity by pressing; whereas, some related vendors have developed a kind of light button in which the push-button unit is light permeable. Therefore, when the push-button is pressed down (ON), the light switch will illuminate, while if the push-button is not pressed down (OFF), the light switch will not illuminate, thereby achieving a function of prompting.

However, when the aforementioned push switches are used, following issues and shortcomings actually exist to be improved.

The conventional light switch can only display light and none of the existing push-buttons is provided with the switch. In addition, the push-button is only usually provided with a function of conducting a circuit, so as to form a connection to equipment which needs to be turned on, and to enable the light to be further provided with a humanized prompting function.

Accordingly, how to solve the aforementioned issues and shortcomings of the prior art is to be studied and researched for improvement by the present inventor and related industries.

### SUMMARY OF THE INVENTION

The primary object of the present invention is to provide an image push-button assembly structure which is constituted primarily by a base, a rest, a display screen and an upper lid, wherein the rest is extended with a fixing element for sheathing a spring and is assembled with a holding space on the base; whereas, the rest is installed with the display screen which is fixed on a display circuit board, followed by covering the upper lid on the rest to allow the display screen to be located in the upper lid and the rest. The display circuit board in the rest that has been pressed down is electrically connected with the circuit board; therefore, all kinds of images of prompting messages can be observed from the display screen, allowing the push-button to be provided with an image display function.

Another object of the present invention is to provide an image push-button assembly structure which is so simple that a user can freely replace the push-button at any time upon dismounting for replacement, without using a professional.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows an exploded view of a preferred embodiment of the present.

FIG. 3 shows a schematic view of a usage state of the present invention in which a push button is pressed down to display an image.

FIG. 4 shows a schematic view of a usage state of the present invention in which a display screen is changed.

### DETAILED DESCRIPTION OF THE PREFERRED EMBODIMENTS

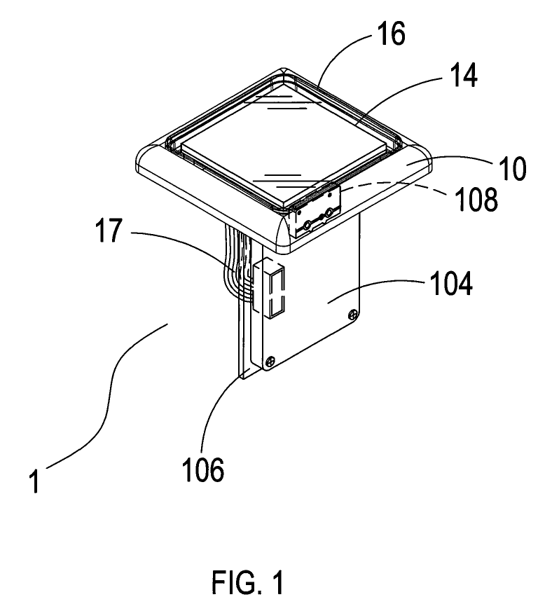

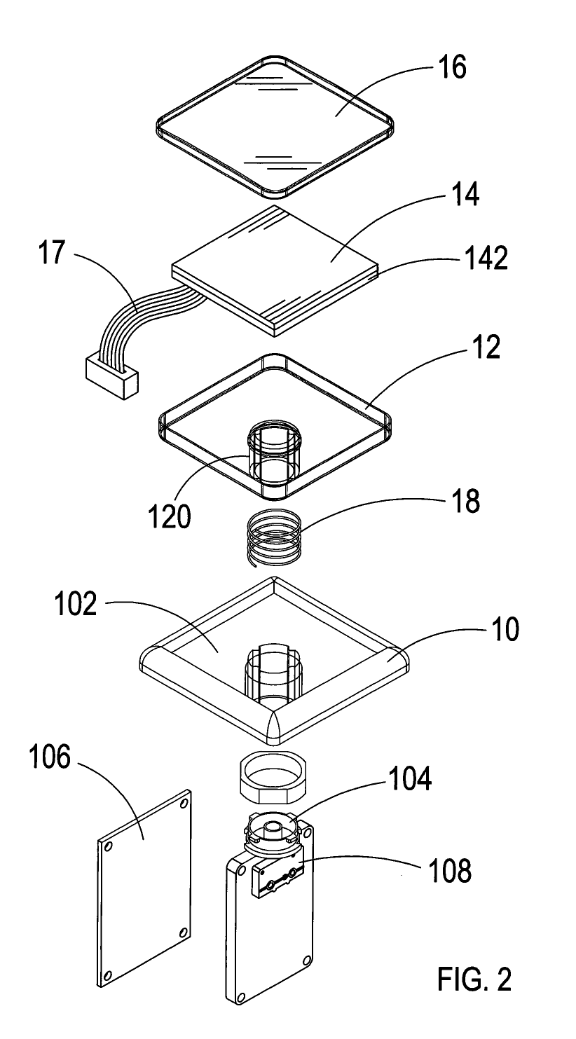

Referring to FIG. 1 and FIG. 2, it shows a three-dimensional view and an exploded view, of a preferred embodiment of the present invention which is an image push-button assembly structure. The push-button structure 1 comprises primarily a base 10, a rest 12, a display screen 14 and an upper lid 16, wherein the rest 12 is extended with a fixing element 120 for sheathing a spring 18 and is assembled with a holding space 102 on the base 10; whereas, the rest 12 is installed with the display screen 14 which is fixed on a display circuit board 142, followed by covering the upper lid 16 on the rest 12 to allow the display screen 14 to be located in the upper lid 16 and the rest 12. Moreover, the base 10 is installed with a fixing plate 104 on which is locked with a circuit board 106 and a switch 108, with the circuit board 106 having a same area as that of the fixing plate 104. The display circuit board 142 in the rest 12 that has been pressed down is electrically connected with the circuit board 106 by a signal wire 17; therefore, all kinds of images of prompting messages can be observed from the display screen 14, thereby allowing the push-button to be provided with an image display function. As the upper lid 16 and the rest 12 are all transparent or semi-transparent, entire transmittance is high, allowing a user to be easily aware of the messages.

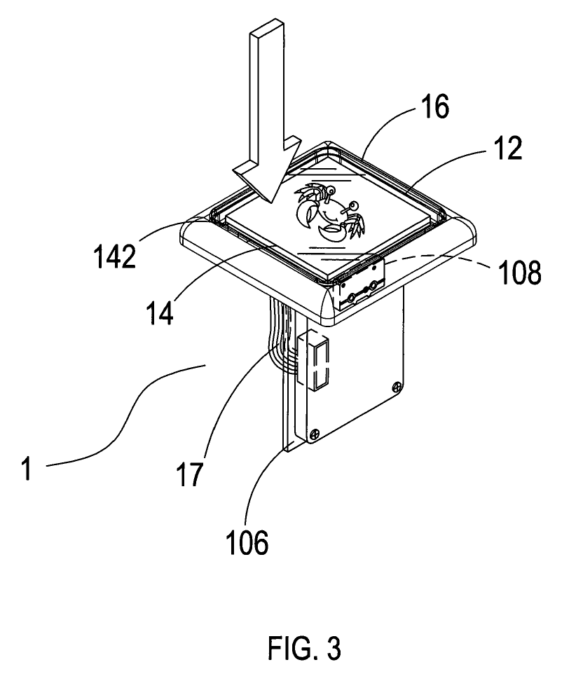

Referring to FIG. 3, it shows a schematic view of a usage state of the present invention in which the push-button is pressed down to display an image. As shown in FIG. 3, along with FIG. 2, the user first activates the switch 108 and then presses the push-button structure 1. When the rest 12 descends by being pressed down from an external force, the display circuit board 142 in the upper lid 16 and the rest 12 will be electrically connected with the circuit board 106 by the signal wire 17, and at this time, signals will be transmitted to the display circuit board 142 through the signal wire 17, allowing the user to be clearly aware of related information through the display screen 14. Moreover, as the rest 12 is extended with the fixing element 120 and the fixing element 120 is sheathed with the spring 18, after the rest 12 has been pressed down, the rest 12 can be restored to an original position by elasticity of the spring 18, facilitating the user to take a next operation.

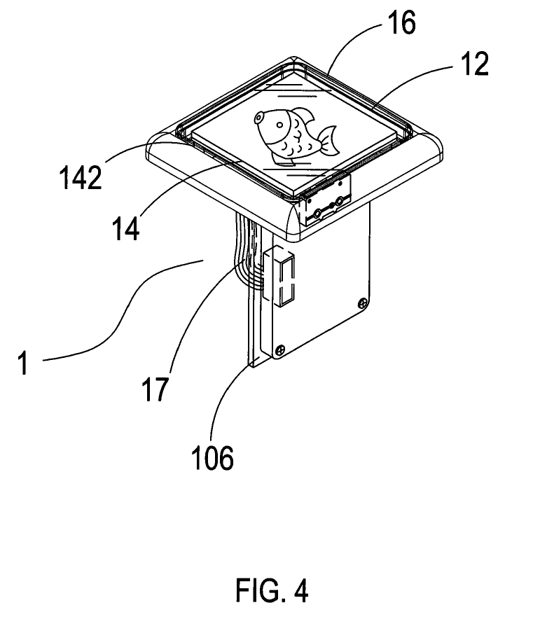

Referring to FIG. 4, it shows a schematic view of a usage state of the present invention in which the display screen is changed. When the user is to change to a different icon, he or she only needs to press down the push-button structure 1 again, allowing the display circuit board 142 in the upper lid 16 and the rest 12 to be electrically connected once more with the circuit board 106 by the signal wire 17 such that the related information can be transmitted to the display circuit board 142 and displayed on the display screen 14 through the signal wire 17 again. If this image is not what the user requires, then the aforementioned operations can be conducted repeatedly until that the image that the user needs is displayed.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An image push-button assembly structure comprising a base which is formed with a holding space; a rest which is extended with a fixing element for sheathing a spring and is assembled with the holding space; a display screen which is installed on the rest and is fixed on a display circuit board; and an upper lid which is assembled with the rest.

2. The image push-button assembly structure according to claim 1, wherein the base is installed with a fixing plate on which is locked with a circuit board and a switch, with the circuit board having a same area as that of the fixing plate.

3. The image push-button assembly structure according to claim 1, wherein the display circuit board is electrically connected with the circuit board to form an electric loop.

4. The image push-button assembly structure according to claim 1, wherein the rest is transparent or semi-transparent.

5. The image push-button assembly structure according to claim 1, wherein the upper lid is transparent or semi-transparent.
